(19) United States
(12) Patent Application Publication
(10) Pub. No.: US 2008/0078331 A1
(43) Pub. Date: Apr. 3, 2008

(54) Artificial water body fish deterrent device

(75) Inventor: Jeffrey G. Weemhoff, Chagrin Falls, OH (US)

Correspondence Address: JOHN F. LETCHFORD, ARCHER & GREINER, P.C., ONE CENENNIAL SQUARE, HADDONFIELD, NJ, 08033, US

(73) Assignee: Meridienne International, Inc., Mantua, OH (US)

(21) Appl. No.: 11/900,269

(22) Filed: Sep. 11, 2007

Related U.S. Application Data
(60) Provisional application No. 60/825,287, filed on Sep. 12, 2006.

(51) Int. Cl. A01K 61/00

(52) U.S. Cl. 119/219

(57) ABSTRACT

A fish deterrent device for discouraging fish from passing through a weir opening and into a filtration unit enclosure of an artificial body of water. The device comprises an array of closely-spaced spiked members that project at least in a direction opposite to the direction of water flow through the weir opening. The device may cover either the weir opening or an opening provided in a weir door of the filtration unit enclosure. The spiked members both physically and visually discourage fish of all sizes from entering the weir opening while easily allowing water to pass therethrough.

### CROSS REFERENCE TO RELATED APPLICATION

This application claims the benefit of U.S. Provisional Patent Application No. 60/825,287, filed Sep. 12, 2006, which is incorporated herein by reference in its entirety.

### FIELD OF THE INVENTION

The present invention relates in general to apparatus for use with artificial bodies of water and in particular to a device for use in deterring fish from entering a filtration region of an artificial water body.

### BACKGROUND OF THE INVENTION

Weirs are commonly found in artificial bodies of water such as swimming pools, artificial ponds, and so forth. A weir typically includes a buoyant, pivotally-mounted door or gate that separates the body of water from its filtration system. In operation, the filtration system's pump creates a gentle circulatory flow that causes water and debris to be pushed toward the weir gate. The pressure exerted by the water causes the gate to pivot whereby water and small debris pass over the weir and, typically, into a debris net or basket (skimmer) of a filtration unit enclosure of the filtration system. As used herein, a “filtration unit enclosure” is an enclosure that includes one or both of a debris skimmer and additional water filtration apparatus. Water that passes the debris net or basket is recirculated to the general body of water via the pump while the blocked debris may be physically removed from the net or basket by hand or a suitable implement.

A unique problem exists in artificial ponds or similar artificial bodies that contain living fish. Fish, especially fry, have a tendency to pass over the weir and into the debris net or basket. If not rescued in a very short time they die from lack of movement and its consequence, lack of oxygen. At present, no satisfactory solutions to this problem have been developed. One attempt, a plastic grate covering the weir door opening, prohibits passage of fish generally larger than approximately ⅝″ in diameter. This solution, however, fails for smaller fish and fry. Furthermore, weir grate openings and weir door grate openings also tend to clog when debris and leaves accumulate in front of the grate. Clogging of the weir opening can result in starving the pump of water and possible pump failure.

An array of equipment used for water filtration and other purposes in connection with artificial and natural bodies of water are also known in the art.

For example, published European Patent Application No. EP 0 958 850 A1 discloses filamentary water filters for filtering water in artificial ponds or aquaria. The filaments hang vertically or substantially vertically inside of a water filtration unit. However, there is no weir door in the filtration unit. Water enters the unit through an unobstructed water inlet pipe and fish may freely enter the inlet pipe. Upon doing so, they would become trapped between the filtration unit housing and the filaments and could not escape, especially since the water line in the filtration unit is below the water inlet. Although not illustrated in the drawings, that document also discusses the use of vertically oriented, cylindrical wire brushes as water filtration means. However, regardless of whether the filtration media are filaments or brushes, their spacing from the water inlet pipes coupled with the lower water level in the filtration unit in relation to the water inlet pipe would render the filtration media useless as a fish deterrent device.

U.S. Pat. No. 6,519,901 describes a spiked protective sheath that can be used in various ways to deter humans and animals (including fish) from harming a structure about which the sleeve is disposed. There is no disclosure of use of the sheath as a filtration element in a weir door or weir opening of the filtration unit of an artificial body of water.

Published UK Patent Application No. GB 2 213 811 A describes a water purification system for fish-containing ponds or tanks. The system employs vertically oriented cylindrical brushes as means for promoting physical flocculation of particles. The brushes neither cover a weir door nor are they disclosed as being a fish deterrent.

U.S. Pat. Nos. 3,799,515 and 4,961,400 describe rotatable cylindrical brushes for aerating bodies of water.

Published U.S. Patent Application No. 2004/0074831 describes a supplemental filtration device for use in the weir opening of a swimming pool filtration system. The device is a grate that is friction-fit in the weir opening and is disposed in front of rather than on or in the weir door.

U.S. Pat. No. 6,457,436 and published U.S. Patent Application No. 2002/0185079 describe rotatable paddles disposed in a large outdoor body of water to be used as a fish deterrent at the water intakes of hydroelectric power plants, municipal water intakes, thermal power plants, and irrigation systems.

U.S. Pat. No. 5,263,833 describes a stationary fish deterrent disposed in a large outdoor body of water to be used as a fish deterrent at water intakes or dam spillways.

U.S. Pat. No. 6,524,028 discloses a substantially horizontal screen disposed for use in an outdoor stream water diversion system.

None of the foregoing apparatus, however, disclose or suggest a weir filtration device that would effectively deter small fish and fry from passing over the weir and into a filtration unit enclosure of an artificial body of water.

An advantage exists, therefore, for a weir filtration device that would effectively deter small fish and fry from passing over the weir and into a filtration unit enclosure of an artificial body of water.

### SUMMARY OF THE INVENTION

The present invention discourages fish from passing through a weir opening and into a filtration unit enclosure of an artificial body of water. According to a first embodiment, the invention provides an opening in the weir door wherein the opening is covered with an array of closely-spaced spiked members that project in a direction opposite to the direction of water flow through the weir opening. The spiked members are connected to a corrosion-resistant frame which is preferably releasably attached to the weir door opening.

The presence of the spiked members both physically and visually discourage fish of essentially all sizes from entering the weir opening, while easily allowing water to pass through the weir door opening. More particularly, from a physical standpoint, the spiked members induce a pricking or jabbing tactile sensation in a fish when the fish's mouth, snout or other body parts come into contact with the spikes. In addition, the outward projection of the spiked members provide a three-dimensional surface that a fish can more readily visually perceive than the typically flat surface of a grate-type weir or weir gate covering. Moreover, the spiked members coupled with the flow of water through the weir opening tend to shred leaves and other debris. Consequently, the leaves and debris tend to disintegrate and eventually pass through the weir opening, thereby reducing the likelihood of clogging of the weir opening and concomitant pump water starvation and failure.

In another embodiment, the weir door need not have an opening and the fish deterrent device may be mounted to the weir opening rather than the weir door of the filtration unit enclosure of the filtration system.

Other details, objects and advantages of the present invention will become apparent as the following description of the presently preferred embodiments and presently preferred methods of practicing the invention proceeds.

### BRIEF DESCRIPTION OF THE DRAWINGS

The invention will become more readily apparent from the following description of preferred embodiments thereof shown, by way of example only, in the accompanying drawings wherein:

FIG. 1 is a front elevation view of an artificial pond filtration unit enclosure;

FIG. 2 is a front elevation view of a fish filtration device according to the present invention;

FIG. 3 is a front elevation view of the fish filtration device of FIG. 2 shown installed in a weir door opening;

FIG. 4 is a schematic side elevation view of an artificial body of water including a filtration system incorporating a weir door and fish filtration device according to the present invention; and

FIG. 5 is a front elevation view of a conventional artificial pond filtration unit enclosure the weir opening of which is covered by a fish filtration device according to the present invention.

### DETAILED DESCRIPTION OF THE INVENTION

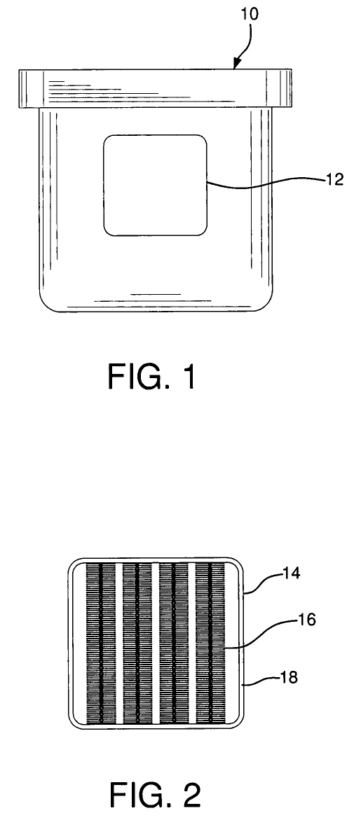

Referring to the drawings wherein like or similar references indicate like or similar elements throughout the several views, there is shown in FIG. 1 an artificial pond filtration unit enclosure 10 having a weir opening 12. During operation of the filtration system, water flows from the artificial body of water through the weir opening whereupon it is normally skimmed and possibly further filtered and then returned to the body of water by the filtration system's water pump.

FIG. 2 depicts a fish deterrent device 14 constructed in accordance with the present invention. It will be understood that device 14 may be sized and configured to accommodate any size filtration unit enclosure 10 and weir opening 12. Device 14 preferably includes an array of closely-spaced, spiked members 16 connected to a frame 18. Spiked members 16 include spikes that project at least in a direction opposite to the direction of water flow through the weir opening. Frame 18 is preferably fabricated from a substantially rigid, corrosion-resistant material such as plastic, stainless steel, or the like. Spiked members 16 may be disposed in any desired orientation with respect to frame 18, e.g., vertical, horizontal, diagonal, curvilinear or any combination thereof. The spiked members provide a physical and visual obstruction to the opening in a weir door as discussed below. In a representative but non-limitative embodiment, the array of spiked members 16 may comprise a plurality of closely-spaced, vertically-oriented, corrosion resistant, e.g., nylon bristle, twisted wire cylindrical brushes.

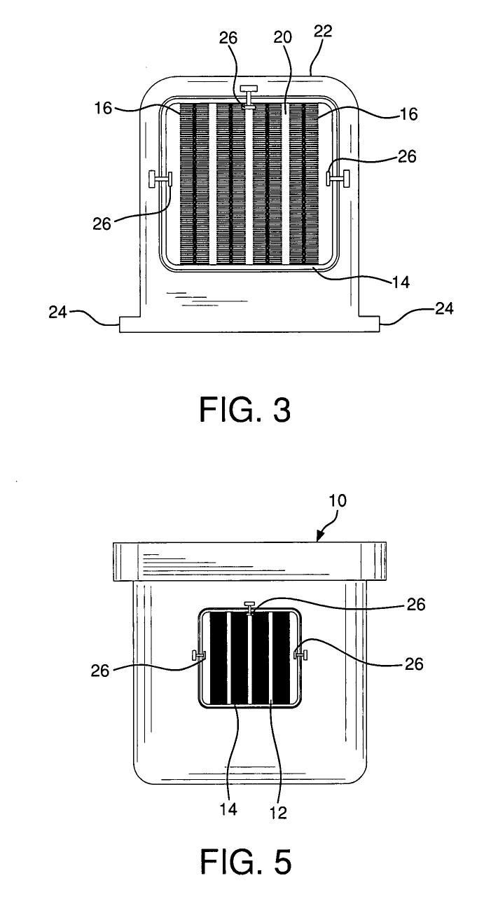

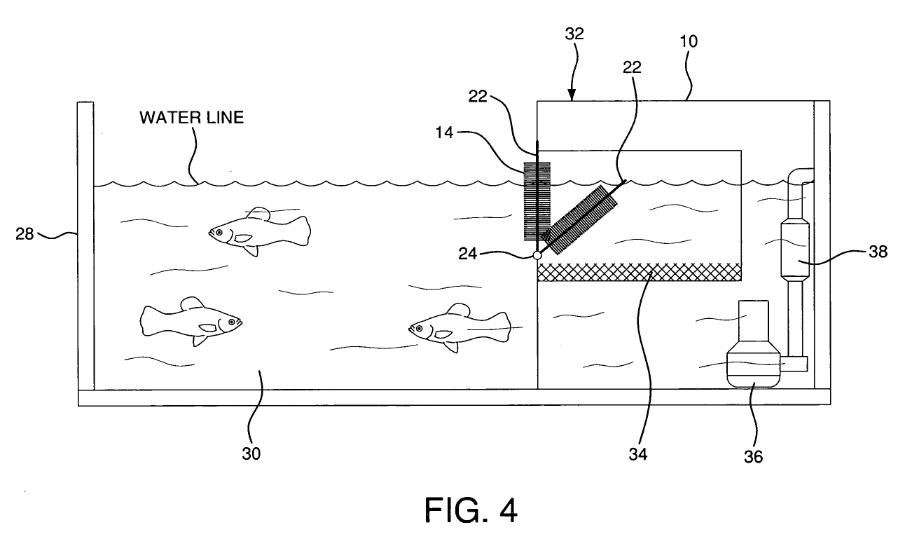

FIG. 3 illustrates fish deterrent device 14 disposed in an opening 20 of a weir door 22. The weir door is a generally planar panel that includes pivot means 24 such as pivot pins or the like at its lower end that permit it to be pivotally connected to the filtration unit enclosure 10 in the manner shown on FIG. 4. Device 14 may be permanently affixed to weir door 22. However, it is preferred that device 14 be removably attached to the weir door so that it may be conveniently cleaned, repaired or replaced. Any fastening means that would enable such removability would be suitable for this purpose including, without limitation, one or more set screws, clamps, or, as illustrated, retainer clips 26 provided on either the front or the back face of weir door 22.

FIG. 4 illustrates how the fish deterrent device 14 according to the present invention could be deployed in connection with the filtration system of an artificial body of water 28 such as an artificial pond or the like. As is conventional, artificial water body 28 comprises a pool or pond region 30 and filtration region 32. The filtration region includes filtration unit enclosure 10, a debris net or basket 34, a pump 36 and piping 38 for returning skimmed and possibly additionally filtered water to pond region 30. As discussed above, weir door 22 is a buoyant door or gate that separates the pond region 30 of water body 28 from filtration region 32 and is pivotally connected to filtration unit enclosure 10 via pivot means 24. FIG. 4 shows weir door 22 in two positions: a vertical orientation when pump 36 is shut off and an inclined position when the pump is turned on. When the pump is activated, the weir door will normally be in an inclined position due to the circulation of water through the system created by pump 36.

In operation, water and debris are transported through the weir opening 12 in filtration unit enclosure 10. Very small and fine debris pass the spiked members 16 of the fish deterrent device 14 and may be captured in debris net or basket 34 from which it may be later removed. Water passes through the debris net or basket whereby it may be further filtered and then recirculated by pump 36 through piping 38. According to the present invention, however, any fish, whether large or small, that encounters the densely-spaced spiked members 16 of device 14 are presented with a physical obstacle that discourages attempts to pass through the weir door opening 20. In the event a fish would attempt to swim past the spiked members, it would experience an unpleasant yet harmless tactile pricking sensation that would encourage the fish to reverse course. The three-dimensional nature of the spiked members also presents a more formidable visual deterrent than the flat surface of a typical weir grate or screen. With such a construction, device 14 provides a fish-friendly deterrent that prevents fish of all sizes from being trapped and harmed in the debris net or basket 34. The spiked members, preferably bristles, also present more surface area than a flat screen or grate of comparable peripheral dimensions, thereby reducing the frequency of maintenance of device 14.

Moreover, the spiked members 16 coupled with the flow of water through the weir opening 12 tend to shred leaves and other debris. Consequently, the leaves and debris tend to disintegrate and eventually pass through the weir door opening 20, thereby reducing the likelihood of clogging of the weir opening and concomitant pump water starvation and failure.

As shown in FIG. 5, it is also contemplated that the weir door 22 need not have an opening and the fish deterrent device 14 may be mounted, preferably removably mounted, to the filtration unit enclosure 10 to cover the weir opening 12 thereof. In this regard, device 14 may be removably mounted to filtration unit enclosure 10 by any suitable means 26 such as, for example, set screws, clamps, or retainer clips. It is also possible that device 14 may be releasably received in weir opening 12 (or the opening of a weir door) by a friction or interference fit.

Although the invention has been described in detail for the purpose of illustration, it is to be understood that such detail is solely for that purpose and that variations can be made therein by those skilled in the art without departing from the spirit and scope of the invention as claimed herein.

What is claimed is:

1. A weir door for use with a filtration unit enclosure of an artificial body of water, said weir door comprising:
a panel;
means carried by the panel for connecting the panel to a filtration unit enclosure of an artificial body of water;
an opening in the panel for permitting water passage therethrough;
fish deterrent means covering said opening for permitting passage of water and deterring passage of fish therethrough, said fish deterrent means comprising an array of spiked members projecting from the panel in at least a direction opposite to the direction of water flow through a weir opening of a filtration unit enclosure of an artificial body of water.

2. The weir door of claim 1 wherein said fish deterrent means are removably connected to the weir door.

3. The weir door of claim 1 wherein said fish deterrent means comprise a plurality of brushes.

4. The weir door of claim 3 wherein said brushes are cylindrical.

5. Fish deterrent means for use with a weir door of a filtration unit enclosure of an artificial body of water, wherein the weir door includes a panel, means carried by the panel for connecting the panel to a filtration unit enclosure of an artificial body of water, and an opening in the panel for permitting water passage therethrough, the fish deterrent means being operable to cover the opening for permitting passage of water and deterring passage of fish therethrough, the fish deterrent means comprising an array of spiked members projecting from the panel in at least a direction opposite to the direction of water flow through a weir opening of a filtration unit enclosure of an artificial body of water.

6. The fish deterrent means of claim 5 wherein said fish deterrent means are removably connected to the weir door.

7. The fish deterrent means of claim 5 wherein said fish deterrent means comprise a plurality of brushes.

8. The fish deterrent means of claim 7 wherein said brushes are cylindrical.

9. Fish deterrent means for use with a filtration unit enclosure of an artificial body of water, wherein the filtration unit enclosure includes a weir opening, the fish deterrent means being operable to cover the weir opening for permitting passage of water and deterring passage of fish therethrough, the fish deterrent means comprising an array of spiked members projecting from the filtration unit enclosure in at least a direction opposite to the direction of water flow through the weir opening.

10. The fish deterrent means of claim 9 wherein said fish deterrent means are removably connected to the filtration unit enclosure.

11. The fish deterrent means of claim 9 wherein said fish deterrent means comprise a plurality of brushes.

12. The fish deterrent means of claim 11 wherein said brushes are cylindrical.
